(19) United States
(12) Patent Application Publication
(10) Pub. No.: US 2026/0149073 A1
(43) Pub. Date: May 28, 2026

(54) METHOD FOR RECYCLING ALKALI METAL BATTERIES AND BATTERY PROCESSING SYSTEM

(71) Applicant: DUESENFELD GMBH, Wendeburg (DE)

(72) Inventor: Till BUSSMANN, Burgwedel (DE)

(21) Appl. No.: 19/122,792

(22) PCT Filed: Oct. 26, 2023
(86) PCT No.: PCT/EP2023/080015

§ 371 Date: Apr. 21, 2025

(30) Foreign Application Priority Data
Oct. 26, 2022 (EP) 22203938.0

(51) Int. Cl. H01M 10/54

(52) U.S. Cl. CPC H01M 10/54

(57) ABSTRACT

The invention relates to a method for recycling alkali metal batteries (12), in particular Li batteries or Na batteries, which have an active material, a carrier foil on which the active material is arranged, binder by means of which the active material is bound to the carrier foil, a liquid electrolyte, conducting salt (38) and a housing that encloses the active material, carrier foil and binder, with the step of comminuting the alkali metal batteries (12) such that the comminuted material, the black matter (30), which contains the active material and the binder, is produced, with the steps of washing the comminuted material with a washing solvent (36) such that conducting salt (38) is washed out and the binder is not washed out such that low-conducting-salt comminuted material and a washing liquid (40) are obtained, regenerating the washing solvent (36) from the washing liquid (40), and in particular by distilling, and washing the comminuted material with at least some of the regenerated washing solvent (36). The invention also relates to a battery preparation system for recycling alkali metal batteries (12), in particular Li batteries or Na batteries.

The invention relates to a method for recycling alkali metal batteries, in particular Li batteries or Na batteries, which comprises (a) an active material, particularly graphite or silicon, (b) a carrier foil on which the active material is arranged, (c) a binder with which the active material is bonded to the carrier foil, (d) an electrolyte, especially a liquid electrolyte, and (e) a conducting salt. Preferably, the alkali metal battery also has a housing; however, it can be housing-free. The method comprises the step of comminuting the alkali metal batteries, resulting in comminuted material, the black mass that contains the active material and the binder.

According to a second aspect, the invention relates to a battery processing system for recycling alkali metal batteries, in particular Li batteries oder Na batteries with (a) a comminution system for comminuting the alkali metal batteries.

Alkali metal batteries are being used on a large and increasing scale to supply electrical consumers with energy. In particular, alkali metal batteries are used as traction batteries in electric vehicles. Electric vehicles are being used more frequently in particular because they can lead to lower CO2 emissions during use. In order to reduce the carbon footprint of electric vehicles, it is desirable to process alkali metal batteries as efficiently and resource-conserving as possible.

CN 103 825 064 A describes a method in which the electrolyte is washed out of intact batteries. After distilling the electrolyte, part of the distillate is reused to wash out the electrolyte. After removing the electrolyte, the housing is sawn off at the head end and the electrodes are removed. The electrodes are unwound and divided into a positive electrode, separator and negative electrode. This type of process is complex and very demanding in terms of process engineering, especially when a large number of differently constructed batteries are processed.

CN 110 380 150 describes a method in which the battery is first dismantled. The electrolyte is then washed out with an organic solvent and an organosiloxane and the resulting mixture is heated so that the conducting salt reacts with the organosiloxane and precipitates. This makes it more difficult to recover the conducting salt.

CN 113 322 380 describes a method in which the batteries are discharged and comminuted. The electrolyte is separated from the comminuted material by filtering and limewater is added so that fluorine components precipitate as calcium fluoride.

WO 2014/208597 A1 describes a method in which the electrolyte is washed out of intact batteries. The resulting solution is mixed with water or acid and evaporated under vacuum so that fluorine components are expelled as hydrogen fluoride.

The invention is based on the task of improving the recycling of alkali metal batteries.

The invention solves the problem by way of an invention according to the preamble comprising the steps (ii) washing the comminuted material with a washing solvent so that conducting salt is washed out and the binder is not washed out, resulting in comminuted material with a low conducting salt content and a washing liquid, (iii) regenerating the washing solvent from the washing liquid and (iv) washing the comminuted material with at least one part of the regenerated washing solvent.

According to a second aspect, the invention solves the problem by way of a battery processing system according to the preamble with (b) a washing device that is designed and arranged to wash at least a fraction of the comminuted material, in particular the black mass, with a washing solvent, resulting in comminuted material with a low conducting salt content and a washing liquid, and (c) a regenerator that (i) is designed to automatically regenerate washing solvent from the washing liquid, (ii) comprises a feed line that is connected to the washing device to guide washing liquid from the washing device to the regenerator, and (iii) comprises a return line that is connected to the washing device for guiding washing solvent from the regenerator to the washing device.

The advantage of the invention is that the conducting salt can usually be recovered on a large scale. The conducting salt recovered in this manner can be reused in alkali metal batteries. To this end, it may be advantageous to separate the conducting salt from the washing liquid or a fraction of the washing liquid. In addition, it may be advantageous to then purify the conducting salt, for example by crystallisation and/or refining.

Preferably, the washing of the comminuted materal and/or the regeneration of the washing solvent is conducted in such a way that at least 50 mol %, in particular at least 70 mol %, in particular at least 80 mol %, preferably at least 90 mol %, particularly preferably at least 95 mol %, of the at least one conducting salt and/or the anion of the at least one conducting salt or the anions of the at least one conducting salt is retained unchanged and, in particular, is separated during regeneration. For example, so little water and/or so little acid is preferably added to the electrolyte and/or the comminuted material that at least 80 mol %, preferably at least 90 mol %, especially preferably at least 95 mol % of the conducting salt and/or the anion of the conducting salt remains unchanged.

In addition, it is advantageous that the method can usually be carried out and, according to one preferred embodiment, is carried out in such a way that essentially no hydrogen fluoride is formed during the washing out of the conducting salt and/or during regeneration. As a result, according to one preferred embodiment, the fluorine bound in the conducting salt can be recovered to a large extent, preferably at least 95 percent by weight, in particular at least 97 percent by weight, especially preferably at least 99 percent by weight.

The characteristic that essentially no hydrogen fluoride is formed is understood in particular to mean that when the conductive salt is washed out and/or during regeneration, at most 5 mol %, in particular at most 2 mol %, preferably at most 1 mol %, particularly preferably at most 0.1 mol %, in particular particularly preferably at most 0.05 mol %, of the fluorine in the alkali metal batteries reacts to form hydrogen fluoride.

The electrolyte is understood particularly to mean a solution composed of a conducting salt solvent and the conducting salt dissolved in it.

It is also beneficial that the electrolyte can often be recovered with a comparatively high degree of purity. It has been shown that it is possible to recover such pure electrolyte that it can be reused to produce alkali metal batteries and can be used according to a preferred embodiment.

Within the scope of the present description, an alkali metal battery is understood to mean a battery in which an alkaline metal, in particular sodium or lithium, or a compound of an alkaline metal migrates from one electrode to the other during the release of electrical energy. It is possible, but not essential, that the oxidation and/or charge of the alkaline metal changes in the process.

An alkali metal battery is also understood particularly to mean an alkali metal rechargeable battery. A rechargeable battery refers to a battery that can be recharged. In particular, a Li battery is also understood to mean a rechargeable lithium battery, i.e. a rechargeable battery.

Examples of alkali metal batteries are lithium ion rechargeable batteries such as the lithium cobalt dioxide rechargeable battery, the lithium polymer rechargeable battery, the lithium manganese rechargeable battery, the lithium nickel cobalt manganese rechargeable battery, the lithium iron phosphate rechargeable battery, the lithium iron yttrium phosphate rechargeable battery, the lithium titanate rechargeable battery, the lithium metal polymer rechargeable battery and lithium rechargeable batteries with metallic lithium, as well as the lithium air rechargeable battery, lithium sulphur rechargeable battery, the sodium nickel chloride high-temperature battery, the sodium sulphur rechargeable battery and the sodium ion rechargeable battery.

The comminuted material is understood to mean the material that results from comminuting the alkali metal batteries.

The black mass refers in particular to the fraction of the comminuted material that contains graphite and/or silicon. In particular, black mass contains at least 30 percent by weight, especially at least 40 percent by weight, of graphite. The black mass preferably comprises at least 10 percent by weight of transition metals and/or their compounds. For example, the black mass contains at least 5 percent by weight of nickel and/or 3 percent by weight of cobalt. However, this is not essential. This indication of weight refers to the weight of the nickel or cobalt and corresponds to the proportion in percent by weight that would be obtained is all nickel or cobalt atoms were present in elementary form, i.e. not in compounds.

Specifically, the black mass is the material obtained by separating plastic particles, in particular comminuted housing and/or comminuted separator foils of the alkali metal batteries, from comminuted material. A separator foil refers in particular to a foil that separates the anode from the cathode.

The washing of the comminuted material is understood to mean that either the comminuted material directly or a fraction of the comminuted material, especially the black mass, is brought into contact with the washing solvent in such a way that the conducting salt is at least partially dissolved by the washing solvent. Dissolving the conducting salt produces the washing liquid from the washing solvent.

The characteristic that the conducting salt is washed out means in particular that at least a part, in particular at least half (in mole percent, in particular at least 60 mole percent, especially preferably at least 70 mole percent, especially preferably at least 80 mole percent, especially preferably at least 90 mole percent) of the anions of the conducting salt are removed.

Regenerating the washing solvent from the washing liquid is understood particularly to mean that the washing liquid is treated in such a way that washing liquid is obtained again. In particular, regeneration constitutes a separation of conducting salt from the washing solvent.

The characteristic that the washing solvent is a component of the electrolyte is understood particularly to mean that it is the same substance. Preferably, at least part of the washing solvent was previously contained in an alkali metal battery that was comminuted during the method. At the beginning of the method according to the invention, washing liquid is preferably used which was not contained in an alkali metal battery or was contained in an alkali metal battery and recovered. During the method, conducting salt solvent is washed out of the comminuted material and partially regenerated as washing solvent. Since part of the conducting salt solvent is preferably removed during regeneration, the proportion of conducting salt solvent in the washing solvent continuously increases.

In other words, the comminuted material is preferably washed with a component of its own conducting salt solvent.

Comminution refers in particular to comminution in the sense of mechanical process engineering. In particular, comminution thus refers in particular to the shifting of the object size distribution into a finer size range.

In particular, comminution is an irreversible reduction in size of the object, for example the alkali metal battery. In particular, comminution is a lifting of the material bond of the object that does not take place along a joint.

In particular, comminuting is not dismantling.

Comminuting is preferably (a) pressure comminuting, in which the object is crushed between two tool surfaces, (b) impact comminuting, in which the object rests on one tool surface and is crushed by impact with a second movable tool, (c) friction comminuting, in which the object is stressed by two oppositely moving tool surfaces, (d) cutting comminuting, in which the object is cut into two parts by means of at least two cutting edges and/or (e) impact comminuting in which the object is thrown against a wall, impacts against a moving tool or in which two objects are brought into collision.

Comminution, especially cutting comminution, has the advantage that the proportion of very small plastic particles that form during the comminution of the housing is comparatively small. Preferably, cutting comminution is carried out in such a way that the proportion by weight (in pieces, i.e. in particular not in percent by weight) of plastic particles produced during the comminution of the housing with a weight that is less than one tenth of the median weight of the plastic particles produced during the comminution of the housing is at most one third, in particular at most one tenth, of the proportion by weight of plastic particles produced during the comminution of the housing and with a weight above the median weight. Machining processes, such as sawing, produce many small plastic particles that are often difficult to separate in the subsequent process.

Comminution is preferably carried out with a solid comminuting tool. The advantage of this is the lower level of contamination of the comminuted material. If a liquid comminution tool is used, for example water during water jet cutting, this causes contamination of the comminuted material.

Preferably, at least half (in percent by weight), especially 90 percent by weight, of the electrodes are severed during comminution.

Severing the electrodes usually causes a mixing of substances that were separate in the battery, especially cathode and anode coatings. Surprisingly, it has been shown that it is possible to separate the individual components to such an extent that mixing is a tolerable disadvantage.

Preferably, at least half (in number), especially at least 90 percent, of the carrier foils and/or separator foils are severed, in particular cut through, at least once during comminution. Indeed, smaller carrier foil particles are more difficult to separate from the other components of the comminuted material.

In particular, the comminuted material contains both comminuted electrodes and particles of comminuted housing and/or comminuted separator foil. The housing is the structure that surrounds the electrodes and shields against the surrounding environment. Preferably, the housing is comminuted using the same comminution system and/or at the same time as the other components of the alkali metal battery. Preferably, the housing and the carrier foil are comminuted simultaneously, i.e. using the same tool and at the same time. In particular, the housing and the carrier foil are cut, wherein both the housing and/or the separate foil and the carrier foil are cut during the cutting processes.

Alternatively or additionally, regeneration may comprise, for example, a separation of the conducting salt by reducing the temperature.

The characteristic of washing the comminuted material with at least one part of the regenerated washing solvent is understood to mean that the regenerated washing solvent is at least partially brought back into contact with the comminuted material for the purpose of washing out the conducting salt. In other words, the washing solvent is at least partially circulated.

The washing of the comminuted material with the washing solvent preferably occurs at a temperature of at most 80° C., in particular at most 70° C., preferably at most 60° C., especially preferably at most 55° C., particularly preferably at most 50° C., particularly preferably at most 45° C., in particular at most 40° C. Low temperatures do slow down the washing out of the conducting salt, but they significantly reduce the decomposition of the conducting salt and/or the formation of hydrogen fluoride.

The electrolyte contains a conducting salt solvent for dissolving the conducting salt. The conducting salt solvent may be a pure substance. Alternatively, the conducting salt solvent is a mixture of at least two pure substances. The electrolyte also contains the conducting salt.

The electrolyte is understood in particular to mean a liquid or a solid that contains ions, namely those of the conducting salt.

The conducting salt is understood to mean a compound that is composed of an anion and a cation and is dissolved in the conducting salt solvent. In particular, the anion is an alkali metal anion which is released or absorbed from the cathode during charging and discharging and/or released or absorbed by the anode. It is possible that the alkali metal batteries contain multiple substances that act as conducting salt. In this case, conducting salt refers to the entirety of all of these substances.

Preferably, the conducting salt solvent contains carbonic acid methyl ethyl ester, i.e. ethyl methyl carbonate (EMC), and/or carbonic acid dimethyl ester, i.e. dimethyl carbonate (DMC).

If—as intended according to a preferred embodiment—the comminuted material is washed in batch operation, the comminuted material is preferably washed at least twice, in particular at least three times, preferably at least four times, in particular at least five times, each time with a new washing solvent. Preferably, it is washed at most 1000 times. It has been found that washing at least once often leads to unsatisfactory purities of the recovered graphite and/or conducting salt.

If—as intended according to an alternatively preferred embodiment—the comminuted material is washed continuously or semi-continuously, the washing solvent is preferably supplied in such a way that, at the end of washing, a concentration of conducting salt in the washing solvent is as high as it would be if the comminuting material had been washed at least twice, in particular at least three times, preferably at least four times, in particular at least five times, each time with new washing solvent in batch operation.

According to one preferred embodiment, the method includes the step of separating the black mass from a residual fraction, especially by classifying or sieving. Preferably, the obtained black mass is washed with the washing solvent. Alternatively or additionally, the separation of the black mass can also include froth flotation. Again, alternatively or additionally, the separation may comprise preparation of a suspension and centrifugation of the suspension. Since black mass should consist of as much graphite as possible, with which the anode is usually coated, this graphite usually consists of particles that are small compared to the particles of the housing and/or the carrier foil, sieving, in particular air jet sieving, has proven to be advantageous.

The step of separating the black mass from the residual fraction is carried out on the comminuted material, in particular the dried comminuted material. The residual fraction is the material that remains after the black mass has been separated. In particular, the residual fraction and the black mass form the comminuted material, especially the dried comminuted material. Preferably, the residual fraction contains particles of comminuted housing and/or comminuted separator foils and/or particles of comminuted carrier foils.

Preferably, the separation of the black mass from the residual fraction is carried out in such a way that the proportion by weight of plastic particles in the black mass is at most one fifth of the proportion by weight of plastic in the residual fraction. As a result, the washing solvent does not or hardly comes into contact with plastic, i.e. plastic or paper, when washing the comminuted material, in particular the black mass. Swelling of the plastic and/or contamination of the washing solvent with plastic or plastic components, which otherwise frequently occurs, is avoided. During swelling, plastic can become stickier, which can make it more difficult to separate the black mass from the plastic after washing.

In particular, the separation of the black mass from the residual fraction comprises or is a separation of the black mass from plastic particles. In particular, the plastic particles contain particles created during comminution of the alkali metal batteries by comminuting the housing.

The separation of the comminuted material, especially the black mass, from the washing solvent is carried out, for example, by filtering.

The invention therefore also encompasses a method comprising the steps (i) comminuting the alkali metal batteries, resulting in comminuted material that contains active material and binder, (ii) then separating the black mass from the comminuted material, especially by classifying or sieving, (iii) washing the black mass of the comminuted material with a washing solvent so that conducting salt is washed out and the binder is not washed out, thereby obtaining black mass with a low conducting salt content and a washing liquid, (iv) regenerating the washing solvent from the washing liquid, particularly by way of distillation, and (v) washing the black mass with at least a part of the regenerated washing solvent. As a result, the conducting salt can usually be recovered with a particularly high degree of purity. The preferred embodiments specified in this description also apply for this invention. This method preferably also comprises the steps described for the other methods according to the invention.

Preferably, the washing solvent is a component of the electrolyte. Preferably, the washing solvent consists of at least 50 percent by weight, preferably at least 70 percent by weight, particularly preferably at least 85 percent by weight, especially preferably at least 95 percent by weight, particularly preferably at least 98 percent by weight, of a compound or compounds that are a component of the electrolyte.

It is favourable if the washing solvent contains at least essentially no diluent. This means in particular that at most 20 percent by weight, in particular at most 15 percent by weight, especially preferably at most 10 percent by weight, preferably at most 5 percent by weight of the washing solvent consists of substances that are not also contained in the electrolyte of the alkali metal batteries.

It is favourable if the washing solvent is essentially not brought into contact with water. The characteristic that the washing solvent is essentially not brought into contact with water is understood particularly to mean that contact with water, which causes a reaction of at least 5 mol %, in particular more than 1 mol %, especially preferably more than 0.1 mol %, of the conducting salt, does not take place. In particular, no water is added to the washing solvent.

It is favourable if the washing solvent contains at least two different solvents. This enables increased solubility of the conducting salt.

Preferably, the washing solvent contains at least 5 percent by weight, in particular at least 10 percent by weight, especially preferably at least 15 percent by weight, in particular at least 20 percent by weight, especially preferably at least 25 percent by weight, of a first pure substance (first washing solvent pure substance) and at least 5 percent by weight, in particular at least 10 percent by weight, especially preferably at least 15 percent by weight, in particular at least 20 percent by weight, especially preferably at least 25 percent by weight, of a second pure substance (second washing solvent pure substance). The first pure substance is preferably ethyl methyl carbonate. The second pure substance is preferably dimethyl carbonate.

Preferably, a washing solvent main component concentration of the main component of the washing solvent (measured in percent by weight) deviates by at most a factor of 10, in particular at most a factor of 9, in particular at most a factor of 8, in particular at most a factor of 7, in particular at most a factor of 6, in particular at most a factor of 5, in particular at most a factor of 4, in particular at most a factor of 3, in particular at most a factor of 2, from a conducting salt solvent main component concentration of the main component of the conducting salt solvent.

The factor is calculated by determining the maximum from the quantity containing the concentration of the main component of the washing solvent and the concentration of the main component of the conducting salt solvent. The factor is the quotient of said maximum (as numerator) and the minimum of the given quantity (as denominator).

The main component is the pure substance which contains the largest proportion in percent by weight of washing solvent or conducting salt solvent.

The conducting salt solvent is optimised to dissolve the conducting salt as effectively as possible. The washing solvent is therefore generally able to dissolve the conducting salt particularly effectively if its main component corresponds as closely as possible to the main component of the conducting salt solvent.

Preferably, a washing solvent secondary main component concentration (measured in percent by weight) deviates by at most a factor of 10, in particular at most a factor of 9, in particular at most a factor of 8, in particular at most a factor of 7, in particular at most a factor of 6, in particular at most a factor of 5, in particular at most a factor of 4, in particular at most a factor of 3, in particular at most a factor of 2, from a conducting salt solvent secondary main component concentration. The secondary main component is the pure substance which contains the second-largest proportion in percent by weight of washing solvent or conducting salt solvent. This further improves the solubility of the conducting salt in the washing solvent.

Preferably, the washing solvent is selected in such a way that it does not react with the conducting salt during washing.

Preferably, the washing solvent is selected in such a way that it does not form a compound with lithium during washing.

Preferably, the comminuted material, especially the black mass, is moved, for example agitated or rotated in a rotating drum, during washing of the comminuted material, especially the black mass.

Washing may be carried out continuously, discontinuously (i.e. in batch operation) or semi-continuously.

The comminuted material, especially the black mass, is preferably washed until at least 70 percent by weight, especially at least 75 percent by weight, especially at least 80 percent by weight, especially at least 85 percent by weight, especially at least 90 percent by weight, especially at least 95 percent by weight, of the conducting salt is removed.

For example, this can be determined by taking samples of the comminuted material, especially black mass, at regular intervals and determining the conducting salt content. This can be achieved, for example, by means of nuclear magnetic resonance (NMR) measurement.

Alternatively, the concentration of conducting salt in the washing liquid is continuously monitored, for example also by means of (NMR) measurement. This concentration follows an extraction curve in which the concentration of conducting salt is plotted against the overall quantity of washing solvent used. The extraction curve is strictly monotonically decreasing. The measured values are adjusted using a parameterised model function (curve fitting), wherein the parameters of the model function are selected in such a way that the original concentration can be determined from them. This model function can be used to calculate the concentration at which the predetermined proportion of conducting salt is removed. If a measured value is measured that is smaller than this concentration, washing is terminated.

Again, as an alternative, preliminary tests can determine how often and/or how long washing solvent must be added and discharged in order to remove the predetermined proportion of conducting salt.

According to one preferred embodiment, the regeneration of the washing solvent comprises distillation, especially vacuum distillation of the washing liquid.

Vacuum distillation is performed at a regeneration temperature. The regeneration temperature is preferably at most 100° C., particularly at most 80° C., particularly at most 70° C., particularly at most 60° C., particularly at most 55° C., particularly at most 52° C., particularly at most 50° C., particularly at most 48° C., particularly at most 45° C.

Preferably, the regeneration of the washing solvent is carried out in such a way that the conducting salt, especially lithium hexafluorophosphate, and/or the anion of the conducting salt does not decompose and/or does not react chemically to at least 80 mol %, in particular to at least 90 mol %.

In particular, essentially no calcium compound is added and/or fluorine is not precipitated as calcium fluoride. The characteristic that essentially no calcium compound is added is understood to mean in particular that at most 5 percent by weight, in particular at most 1 percent by weight, particularly preferably at most 0.1 percent by weight, of a calcium compound is added to the washing solvent.

The regeneration of the washing solvent is preferably carried out in such a way that the conducting salt is recovered. Alternatively or additionally, the regeneration of the washing solvent is carried out in such a way that at least 80 mol %, in particular at least 85 mol %, especially preferably at least 90 mol %, in particular preferably at least 95 mol %, of the anions of the conducting salt are deposited unchanged in a compound. In other words, a substance is preferably deposited during regeneration that contains the same anion as the conducting salt but possibly, although not necessarily, a different cation.

The regeneration temperature is the highest temperature that prevails in the vacuum distiller at a point that comes into contact with conducting salt (dissolved or undissolved).

Vacuum distillation is preferably performed at a pressure below the vapour pressure of the washing solvent at the regeneration temperature.

According to one preferred embodiment, the distillation pressure p₄₂ is selected in such a way that both ethyl methyl carbonate (EMC, carbonic acid ethyl methyl ester) and dimethyl carbonate (DMC, carbonic acid dimethyl ester) evaporate.

Preferably, the distillation pressure p₄₂ is selected in such a way that no substances evaporate whose boiling point at normal pressure (1013 hPa) is above a separation boiling point Tₜᵣₑₙₙ. The substances with a boiling point that corresponds to the separation boiling point Tₜᵣₑₙₙ are referred to as low boilers.

The higher the separation boiling point Tₜᵣₑₙₙ, the more components of the electrolyte of the alkali metal batteries are part of the washing solvent. Preferably, the separation boiling point Tₜᵣₑₙₙ is selected in such a way that at most five components, especially at most four components, preferably at most three components, especially particularly at most two components, of the electrolyte evaporate.

Preferably, the separation boiling point Tₜᵣₑₙₙ is selected in such a way that at least one component, especially at least two components, preferably at least three components, especially particularly at least four components, of the electrolyte evaporate.

A component of the electrolyte is a pure substance whose proportion in the electrolytes of the alkali metal batteries is at least 0.5 mol %.

Preferably Tₜᵣₑₙₙ>108° C., for example Tₜᵣₑₙₙ=110° C.

The method preferably comprises the step of separating the conducting salt from the washing liquid. A separation residue forms during regeneration of the washing solvent. If regeneration constitutes vacuum distillation, a distillation sump forms. Preferably, the conducting salt is separated from the separation residue, in particular the distillation sump. For example, the conducting salt is separated by crystallisation.

It is favourable if the separated conducting salt is used to produce new alkali metal batteries.

Preferably, the washing solvent consists at least 50 percent by weight of a compound or compounds that are a component of the electrolyte. It is favourable if the method comprises the step of removing washing solvent from a washing solvent cycle in which the washing solvent is conducted.

It is favourable if the removed washing solvent is used to produce new alkali metal batteries.

According to one preferred embodiment, the method comprises the step of milling the low-conducting salt comminuted material. For example, this can be done with a turbo mill, an impact mill or a ball mill. Preferably, the low-conducting salt comminuted material still contains foil components, in particular parts of the carrier foil and/or metal foil components. Preferably, the low-conducting salt comminuted material contains at least one third of the proportion in percent by weight of metal foil components in the comminuted material immediately after comminution; in particular, all metal foil components are still contained therein.

The black mass is preferably sieved out after milling. The black mass is the fraction with the smallest grain size. Preferably, foil components, especially copper and/or aluminium foil components, are separated from the remaining fraction. This is achieved, for example, using a fluidised bed separator or a classifier. As described in the following, the binder is preferably dissolved out of the recovered black mass by means of a binder solvent.

According to one preferred embodiment, the method comprises the step of removing, especially dissolving out, the binder from the low-conducting salt comminuted material, in particular the low-conducting salt black mass, with a binder solvent, thereby obtaining low-conducting salt comminuted material, in particular low-conducting salt black mass. Specifically, the binder solvent is not the washing solvent. In order to be able to reuse the active material, especially the graphite, for producing alkali metal batteries, it must have a high degree of purity. It has been shown that this purity is easier to achieve when the binder is dissolved out.

Although complete removal of the binder is theoretically desirable, it is practically impossible. Preferably at least 50 percent by weight, in particular at least 60 percent by weight, in particular at least 70 percent by weight, in particular at least 80 percent by weight, in particular at least 90 percent by weight, of the binder is removed. Preferably, at most 99 percent by weight of the binder is removed.

Alternatively, the binder solvent is a component of the conducting salt solvent. Although the conducting salt solvent does not dissolve the binder at the operating temperature, surprisingly it has been shown that the conducting salt solvent can dissolve the binder, especially at high temperatures.

Alternatively or additionally, the method preferably comprises the step of dissolving a solid electrolyte out of the low-conducting salt comminuted material, especially the low-conducting salt black mass, using a solvent, thereby obtaining low-conducting salt comminuted material, especially low-conducting salt black mass.

The binder solvent is preferably acetone, γ-butyrolactone (GBL), diethyl carbonate (DEC), dimethylacetamide (DMA), N,N-dimethylformamide (DMF), dimethylsulfoxide (DMSO), 3-heptanone, 3-hexanone, methyl ethyl ketone (MEK), methyl ethyl ketone (MEK), methyl octanoate, supercritical carbon dioxide or a mixture of two, three, four or more of the chemical compounds mentioned.

The binder is preferably dissolved out using at least one diluent. The diluent is preferably γ-butyrolactone (GBL), dimethyl sulfoxide (DMSO), 3-heptanone or 3-octanone. The diluent is used in combination with the binder solvent to dissolve the binder. For example, the binder solvent is mixed with the diluent. However, a diluent does not have to be used.

The binder and/or the solid electrolyte is preferably dissolved out at a temperature of at least 70° C., in particular at least 90° C., in particular at least 110° C., in particular at least 130° C., in particular at least 150° C., in particular at least 175° C., in particular at least 200° C., in particular at least 240° C., in particular at least 260° C., in particular at least 280° C., in particular at least 290° C.

This temperature is preferably lower than the boiling temperature of the binder solvent at the pressure used.

It is favourable if the binder is dissolved out at a temperature that is at most 30 Kelvin, especially at most 20 Kelvin, preferably at most 10 Kelvin, below the boiling temperature of the binder solvent at the respective process pressure.

The binder is preferably dissolved out at an overpressure, for example an overpressure of at least 100 hPa, in particular an overpressure of at least 200 hPa, an overpressure of at least 500 hPa, an overpressure of at least 1000 hPa, an overpressure of at least 2000 hPa, an overpressure of at least 3000 hPa. The overpressure is preferably at most 10 MPa. This overpressure is the process pressure.

Before dissolving out the binder, the low-conducting salt comminuted material, especially the low-conducting salt black mass, is preferably not pyrometallurgically oxidised and/or not heated to a temperature of more than 300° C., in particular of not more than 250° C.

Before dissolving out the binder, the low-conducting salt comminuted material, especially the low-conducting salt black mass, is preferably not heated in a hydrogenous atmosphere.

According to one preferred embodiment, the method comprises the step of post-washing the low-binder comminuted material, especially the low-binder black mass, with a post-washing solvent so that the binder solvent is washed out. The post-washing solvent is preferably an organic solvent. A boiling point of the post-washing solvent is preferably below the boiling point of the binder solvent, preferably below 100° C., especially below 90° C., especially below 80° C., especially below 70° C. at normal pressure. For example, the post-washing solvent is acetone.

The method preferably comprises the step of regenerating the post-washing solvent. This can be done, for example, by way of distillation, especially vacuum distillation. As a result of regeneration, the post-washing solvent is separated from the binder solvent and preferably reused for post-washing.

The washing solvent preferably contains at most 5 percent by weight, preferably at most 3 percent by weight, especially preferably at most 1 percent by weight, in particular essentially no alkaline earth metal hydroxide. The characteristic that there is essentially no alkaline earth metal hydroxide present is understood particularly to mean that a potentially present amount of alkaline earth metal hydroxide can be ignored.

Preferably, the washing solvent is selected in such a way that at most 20 mol %, at most 10 mol %, especially preferably at most 5 mol %, particularly preferably at most 1 mol % of the lithium reacts during washing to become lithium hydroxide. Preferably, the washing solvent is selected in such a way that no lithium hydroxide forms during washing.

Before dissolving out the binder, the low-conducting salt comminuted material, especially the low-conducting salt black mass, is not macerated, i.e. it has not been treated with a mineral acid.

According to one preferred embodiment, the method comprises the step of separating, especially classifying, the low-binder comminuted material, especially the low-binder black mass, thereby obtaining a graphite fraction and a transition metal fraction in which at least one transition metal is enriched compared to the graphite fraction.

However, it is not essential for separation to be carried out on the low-binder comminuted material.

According to one embodiment, the method initially comprises step (i) according to claim 1, then pre-drying, then separating plastic particles, especially particles of the comminuted housing and/or comminuted carrier foil, thus obtaining black mass, then steps (ii), (iii), (iv) according to claim 1, followed by an optional drying of the black mass and classifying of the—possibly dried—black mass.

In this case, drying is preferably conducted in such a way that at least 70 percent by weight, in particular at least 80 percent by weight, especially preferably at least 90 percent by weight, in particular at least 95 percent by weight, of the washing solvent contained in the black mass is removed.

Alternatively or additionally, pre-drying is preferably performed in such a way that at least 50 percent by weight, in particular at least 60 percent by weight, preferably at least 70 percent by weight, especially preferably at least 80 percent by weight, particularly preferably at least 90 percent by weight, of the electrolyte and/or the electrolyte solution are removed.

A transition metal is understood to be the elements that have an incomplete d-subshell or form ions with an incomplete d-subshell. In particular, cobalt and/or nickel are enriched in the transition metal fraction compared to the graphite fraction, preferably by at least the enrichment factor 3 (which means that the concentration of the corresponding transition metal in the transition metal fraction is at least three times greater than the concentration of the corresponding transition metal in the graphite fraction), in particular the enrichment factor 4, in particular the enrichment factor 5, preferably the enrichment factor 6.

It has been shown that a higher enrichment factor can be achieved particularly effectively when as much binder as possible is removed. The exact reason why is not fully known. It is assumed that the binder sticks individual graphite particles to each other and to particles that contain a transition metal or a salt of the transition metal, thereby enabling separation.

Separation may also be or include flotation, especially froth flotation. However, it has been shown that a higher enrichment factor can be achieved by classifying.

The classifying is preferably a fine classifying. It is favourable if classifying is carried out by means of a fine classifier which has a classifying wheel. The classifying wheel can also be referred to as a classification wheel. The classifying wheel features recesses, especially slots. The recesses preferably have a clear width, especially a slot width, of at least 0.1 mm, especially 1 mm, and/or at most 25 mm, especially at most 15 mm, especially preferably at most 10 mm.

The fine classified is preferably designed to rotate the classifying wheel at a classifying wheel rotation frequency between 500 and 20 000 rotations per second. The higher the classifying wheel rotation frequency, the smaller the aerodynamic diameter of the removed fraction.

The recesses and the rotation frequency are preferably selected in such a way that the graphite fraction has a graphite fraction-particle size distribution, wherein 80 percent by volume of the graphite has a particle size of less than 20 μm.

Alternatively or additionally, the recesses and the rotation frequency are selected in such a way that the transition metal fraction has a transition metal fraction particle size distribution, wherein 90% of the particles have a particle size below 35 μm, in particular below 30 μm. Preferably, at least 50% of the particles have a particle size below 25 μm, in particular below 20 μm. It has been shown that this enables an especially high enrichment factor. The particle size is determined according to DIN ISO 13320:2009.

According to one preferred embodiment, the method comprises the step of drying the low-conducting salt comminuted material, especially the low-conducting salt black mass, after washing the comminuted material, especially the black mass, with the washing solvent. Said drying is preferably performed at a temperature of at most 80° C., especially at most 70° C., especially at most 60° C., especially at most 50° C., preferably at most 45° C. This largely prevents hydrogen fluoride from forming. The characteristic that hydrogen fluoride is largely prevented from forming is understood particularly to mean that a hydrogen fluoride concentration during drying in the gas atmosphere is at most 1 mg/m³.

Alternatively, drying is performed at a temperature above the boiling point of the washing solvent. This is advantageous when washing with the washing solvent is carried out until the conducting salt content is so low that at least essentially no hydrogen fluoride forms during the subsequent drying. For example, drying is performed at a temperature of at least 80° C., especially at least 100° C., especially at least 120° C.

Preferably, the method comprises the step: after drying, washing the low-conducting salt comminuted material, especially the low-conducting salt black mass, with a second solvent, the boiling point of which is lower than the boiling point of the washing solvent. If the washing solvent contains two or more components, the second solvent preferably has a lower boiling point than all components of the washing solvent. The comminuted material treated in this manner, especially the black mass treated in this manner, is then preferably re-dried.

After drying, particularly after pre-drying, foil components, especially plastic and/or metal foil elements and/or particles of comminuted housing are preferably separated. In particular, this is achieved by dissolving out the binder. Preferably, separation is carried out in such a way that after separation, a foil weight proportion of foil components is at most one fifth of the foil weight proportion than before separation. As a result, the binder solvent does not or hardly comes into contact with plastic or metal foils when the binder is being dissolved out.

Preferably, the low-binder comminuted material, especially the low-binder black mass, is dried before the binder is dissolved out. Drying is preferably performed at a pressure of at most 300 hPa, particularly at most 10 hPa. The binder solvent is less contaminated as a result.

It is favourable if the graphite of the graphite fraction is used to produce new alkali metal batteries.

It is favourable if the method comprises the following step: separating foil parts from the comminuted material before washing the comminuted material. The resulting comminuted material, which can be referred to as low-foil comminuted material, can be washed effectively with the washing solvent. The foils can be a carrier foil, in particular plastic foils and/or metal foils. For example, it refers to parts of the separator foil and/or aluminium foil and/or copper foil.

According to one preferred embodiment, the method includes the following step: after comminution, preferably after separating foil parts or before separating foil parts and/or particles of comminuted housing and before washing the comminuted material, pre-drying the comminuted material. The pre-drying is preferably performed in such a way that at least 50 percent by weight, in particular at least 60 percent by weight, preferably at least 70 percent by weight, especially preferably at least 80 percent by weight, particularly preferably at least 90 percent by weight, of the electrolyte and/or the electrolyte solution are removed. The pre-drying can be generally referred to as drying.

In particular, the method comprises the steps (a) drying the comminuted material, resulting in dried comminuted material, (b) separating plastic particles, especially particles of comminuted housing and/or comminuted carrier foil and/or comminuted separator foils, from the dried comminuted material, thereby obtaining black mass, wherein (c) the black mass is washed with the washing solvent. The plastic particles are preferably not washed with the washing solvent. This prevents the washing solvent from being contaminated with the components from the plastic. In addition, it prevents the plastic particles from swelling.

Preferably, pre-drying is performed at a pressure of at most 300 hPa and/or a temperature of at most 70° C., especially at most 60° C., especially at most 50° C. Preferably, pre-drying is performed at such a low temperature that at most 5 mol %, especially at most 1 mol % of fluorine in the comminuted material reacts to form hydrogen fluoride.

According to one preferred embodiment, the method comprises the step: before comminution, short-circuiting the batteries until at least 75% of the galvanic elements have a regeneration cell voltage of at most 0.4 volts, particularly at most 0.3 V, preferably at most 0.2 volts, particularly at most 0.15 volts, particularly preferably at most 0.1 volts, particularly 0.05 V.

Short-circuiting the batteries means that the conducting salt can be recovered with a particularly high degree of purity. Why short-circuiting increases the purity of recovered conducting salt has not been fully clarified. Presumably, a regeneration cell voltage that is considerably greater than OV causes heat to develop locally during comminution, which may facilitate the decomposition of conducting salt and/or the formation of hydrogen fluoride.

It should be noted that deep discharging alone does not lead to a regeneration cell voltage of at most 0.2 V. Deep discharging is understood to mean draining the current of the battery until its capacity is almost completely exhausted, particularly to below the end-point voltage. The discharge cut-off voltage can be, for example, 0.1 volts. The energy content of the batteries is very low following deep discharging: on the one hand, the cell voltage has reduced dramatically and on the other, the discharge current that can be achieved is very small. Methods from the prior art therefore only encompass deep discharging.

However, it has been proven that the energy content following deep discharging is high enough to be able to cause the formation of hydrogen fluoride. The quantities of hydrogen fluoride that form during comminution of deeply discharged, but not short-circuited batteries, are indeed comparatively small, but it has been shown that even low levels of contamination of the conducting salt with decomposition products can negatively impact the suitability of the conducting salt and/or the electrolyte for the production of new batteries.

Regeneration cell voltage refers to the cell voltage acting on the respective galvanic element after a given regeneration time, during which the poles of the batteries are not electrically connected. The characteristic that the poles of the batteries are not electrically connected is understood to mean that the poles are insulated from each other, i.e. there is a resistance of at least 1 megohm between the two poles. In other words, no electrical energy is drained from the galvanic element during the regeneration time. In particular, the poles of the galvanic elements of the battery are electrically unconnected during the regeneration time.

The cell voltage increases during the regeneration time. Even discharging a battery to a cell end voltage of, for example, less than 0.2 V, for example 0 V, leads to a regeneration cell voltage that is greater than the cell end voltage.

It has been determined that a battery INR18650-25R from Samsung, made in February 2022, has a cell voltage of 0 V following 1 hour of short-circuiting. The regeneration cell voltage was 1 V. After 3 hours of short-circuiting the regeneration cell voltage was 0.8 V. After 5 hours of short-circuiting the regeneration cell voltage was 0.6 V. After 24 hours of short-circuiting the regeneration cell voltage was 0.2 V

Short-circuiting the batteries until the regeneration cell voltage is at most 0.2 V, in particular at most 0.15 V, in particular at most 0.1 V, can also be referred to as regeneration-safe short-circuiting. It is therefore beneficial to not short-circuit the batteries until after regeneration-safe short-circuiting of the batteries.

It can be determined whether regeneration-safe short-circuiting has taken place by storing the corresponding battery for the regeneration time without an external electrical load and in particular without a short-circuit at 1013 hPa and 23° C., and then measuring the cell voltage. In other words, the rechargeable batteries can also be short-circuited until at least 75% of the galvanic elements have the specified maximum regeneration cell voltage if the batteries are comminuted or otherwise processed before the regeneration time has elapsed. The only decisive factor is whether they are short-circuited so that the specified regeneration cell voltage would not be exceeded after the regeneration time has elapsed.

The regeneration time is 12 hours. It should be noted that this is not a statement of how long the batteries are short-circuited. Rather, the regeneration time is the time that the remain in the non-contacted, in particular non-short-circuited, state after discharging, especially short-circuiting. In particular, short-circuiting the batteries for 12 hours may still lead to a regeneration cell voltage above 0.2 volts.

Preferably, the batteries are short-circuited for a short-circuiting time of at least 8 hours, particularly at least 10 hours, preferably at least 12 hours, especially at least 15 hours, particularly at least 18 hours. It is especially beneficial if the short-circuiting time is at least 20 hours, for example 24 hours. The short-circuiting time is preferably less than 120 hours. This renders it possible—as is intended according to one preferred embodiment—to ensure that at least 90 percent by weight, in particular at least 95 percent by weight, of the conducting salt of the batteries does not decompose during comminution.

Preferably, the steps before washing the black mass are carried out in such a way that the conducting salt of the alkali metal batteries decomposes to at most 10 percent by weight, particularly to at most 5 percent by weight, particularly to at most 3 percent by weight, particularly to at most 1 percent by weight, particularly to at most 0.5 percent by weight, particularly to at most 0.1 percent by weight.

It is beneficial if short-circuiting is performed using a metallic conductor. In the process, the metallic conductor connects the poles of the batteries, i.e. the negative pole and the positive pole. This means that the metallic conductor does not connect the poles of the battery with an electrical resistance or another electrical consumer. It is especially beneficial if the connection of negative and positive pole does not occur by means of a liquid, in particular a salt solution.

Preferably, an electrical resistance between the positive pole of the battery and a negative pole of the battery during short-circuiting is at most 10 ohms, in particular at most 1 ohm, preferably at most 0.3 ohms, especially preferably at most 0.1 ohms.

It is possible, but not essential, to transport the battery following regeneration-safe short-circuiting, particularly over a distance of at least 1 km, particularly at least 5 km. The regeneration-safe short-circuiting minimizes the risk of fire and thus the environmental hazard posed by the battery. Preferably, the battery is not transported over a distance of more than 1 km following regeneration-safe short-circuiting, since such transport may pose a safety risk.

According to one preferred embodiment, the comminuted material is essentially not brought into contact with water before washing. The characteristic that the comminuted material is essentially not brought into contact with water is understood particularly to mean that contact with water, which causes a reaction of at least 5 mol %, in particular more than 1 mol %, especially preferably more than 0.1 mol %, of the conducting salt, does not take place. In particular, comminution is performed without the introduction of water, especially not by means of water jet cutting.

Preferably, the comminuted material at least essentially contains no organic cations. This is understood particularly to mean that a content of substances with organic cations is at most 0.1 percent by weight. Particularly preferably, the comminuted material does not contain any organic cations and/or no double layer capacitors.

Preferably, the active material and/or the electrolyte are essentially not brought into contact with water before and during comminution. This is understood to mean that there is no contact with water that causes a reaction of more than 5 mol %, in particular more than 1 mol %, in particular more than 0.1 mol % of the conducting salt or electrolyte.

Preferably, the active material and/or the electrolyte are essentially not brought into contact with water before and during washing. This is understood to mean that there is no contact with water that causes a reaction of more than 5 mol %, in particular more than 1 mol %, in particular more than 0.1 mol % of the conducting salt or electrolyte.

Preferably, comminution is carried out at a temperature that is so low that at most 2.5 mol %, in particular at most 1 mol %, particularly preferably at most 0.5 mol %, of the fluorine decomposes in relation to the comminuted material.

Preferably, the low-binder comminuted material, especially the low-binder black mass, is macerated with concentrated sulphuric acid and then leached. Due to the fact that it contains barely any binder, the amount of sulphuric acid used is low. This makes it easy to obtain graphite with a low metal ion content. Said graphite can then, where applicable, be reused to produce alkali metal batteries.

The battery processing system according to the invention preferably comprises a separating device that is designed and arranged to separate black mass from the residual fraction. For example, the separating device is a classifier or a sieve.

In summary, the invention also includes the following method for recycling alkali metal batteries, especially Li batteries or Na batteries, comprising
(a) an active material, especially graphite,
(b) a carrier foil on which the active material is arranged,
(c) binder with which the active material is bonded with the carrier foil,
(d) a liquid electrolyte,
(e) conducting salt and
(f) a housing that surrounds the active material, carrier foil and binder, characterised by the steps
(i) optional discharging and short-circuiting so that a regeneration voltage is below 0.2 V, particularly 0.1 V,
(ii) comminuting the alkali metal batteries, resulting in comminuted material, the black mass that contains active material and the binder, and
(iii) optional drying of the comminuted material, especially below 70° C. and/or at a pressure of at most 300 hPa,
(iv) optional separation of the black mass, especially by classifying,
(v) washing the comminuted material, especially the black mass, with a washing solvent so that conducting salt is washed out and the binder is not washed out, thereby obtaining low-conducting salt comminuted material, especially low-conducting salt black mass, wherein the washing solvent is a component of the electrolyte,
   wherein washing is preferably carried out until at most 10 percent by weight, in particular at most 5 percent by weight, particularly preferably at most 1%, in particular at most 1 percent by weight, in particular at most 0.1%, in particular at most 0.1 percent by weight, in particular at most 1%, in particular at most 0.1% of the conducting salt remains,
   the washing solvent is recovered,
   the conducting salt and/or a substance with the same anion as the conducting salt is separated from the residue that forms during recovery of the washing solvent,
   the at least one solvent, which is an electrolyte component and not the washing solvent, is separated from the residue and in particular is recycled for reuse in new batteries,
(vi) optional drying of the low-conducting salt comminuted material, especially the low-conducting salt black mass (which can be carried out at a temperature above the boiling temperature of the washing solvent, preferably below the binder decomposition temperature),
   optional washing with a second washing solvent with a lower boiling point than the washing solvent,
(vii) optionally dissolving the binder out of the low-conducting salt black mass with a binder solvent (which is not the washing solvent), thereby obtaining low-binder comminuted material,
(viii) optional drying of the low-binder comminuted material and
(ix) optional separation, especially classifying, of the low-binder comminuted material, thereby obtaining a graphite fraction and a transition metal fraction, in which at least one transition metal is enriched compared to the graphite fraction,
(x) optional production of new batteries, especially alkali metal batteries, from graphite of the graphite fraction and/or the washing solvent and/or the precipitated conducting salt.

The method preferably comprises the step of washing out binder solvent. This is achieved, for example, using an organic solvent, which can also be referred to as binder wash-out solvent. The binder wash-out solvent preferably has a lower boiling point than the binder solvent. Preferably, the boiling point at normal pressure is below 100° C., especially below 90° C., especially below 80° C., especially below 70° C., especially below 60° C.

In a battery processing system according to the invention, the regenerator is preferably a vacuum distiller that is designed to automatically distil a low-boiler fraction of the washing liquid, wherein the low-boiler fraction forms the washing liquid.

Preferably, the battery processing system has a binder removal system designed to automatically dissolve binder out of the low-conducting salt comminuted material, especially the low-conducting salt black mass, by means of a binder solvent. The binder removal system is preferably arranged downstream of the washing device in the direction of material flow. It is possible, but not essential, for a dryer and/or a separating device to be arranged upstream of the binder removal system in the direction of material flow.

The binder removal system is preferably designed to heat the low-conducting salt comminuted material, in particular the low-conducting salt black mass, to a temperature above a binder decomposition temperature T_{BZ}. The binder decomposition temperature T_{BZ} is the temperature at which half of the binder is decomposed after 30 minutes. This further reduces binder residues so that subsequent separation results in a higher enrichment factor.

Preferably, the battery processing system has a binder removal system designed to automatically dissolve binder out of the—in particular low-conducting salt—comminuted material, especially the—in particular low-conducting salt-black mass, by means of a binder solvent.

If a binder removal system is provided, the battery processing system preferably has a post-washer, which is designed to wash the binder solvent out of the low-binder comminuted material, especially the low-binder black mass, with a post-washing solvent.

In the following, the invention will be explained in more detail with the aid of the accompanying drawing. They show:

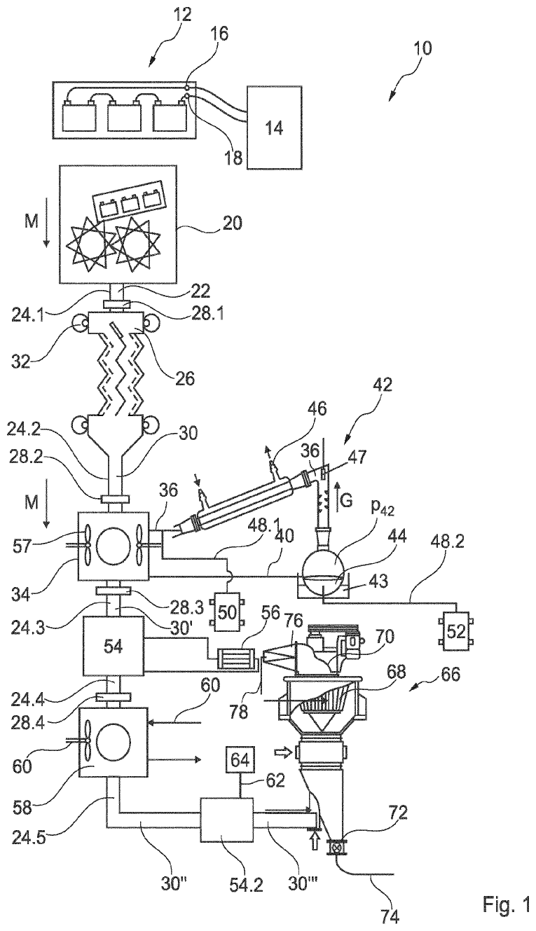

FIG. 1 a flow diagram of a battery processing system according to the invention,

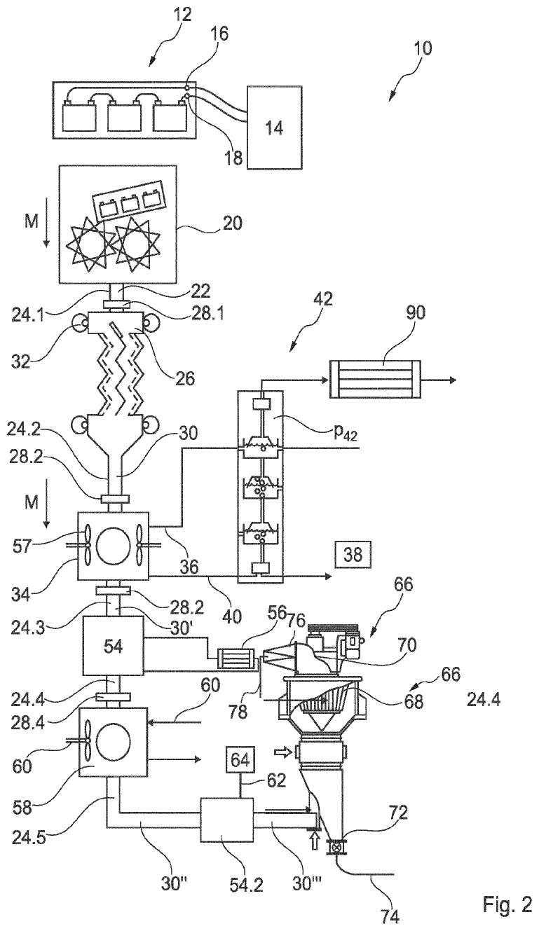

FIG. 2 a flow diagram of a battery processing system according to the invention in accordance with a second embodiment,

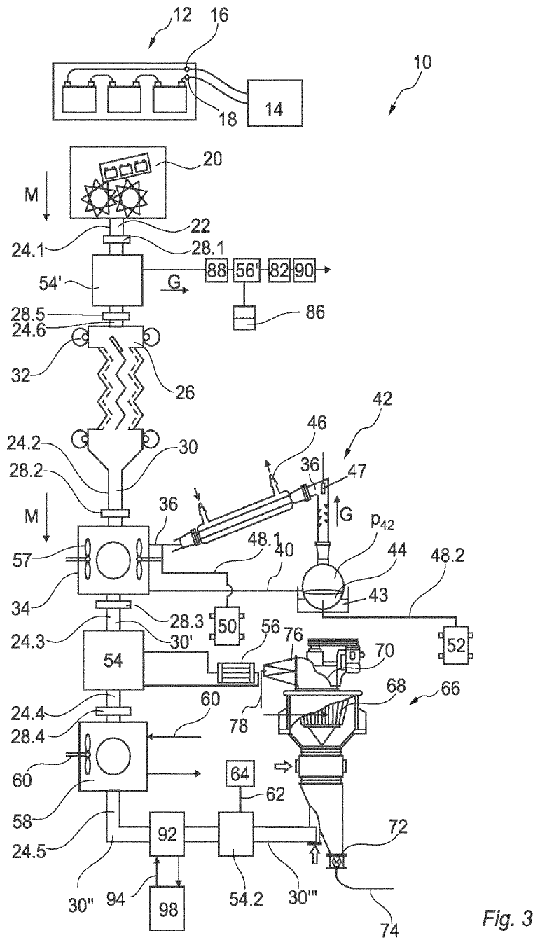

FIG. 3 a flow diagram of a battery processing system according to the invention in accordance with a third embodiment and

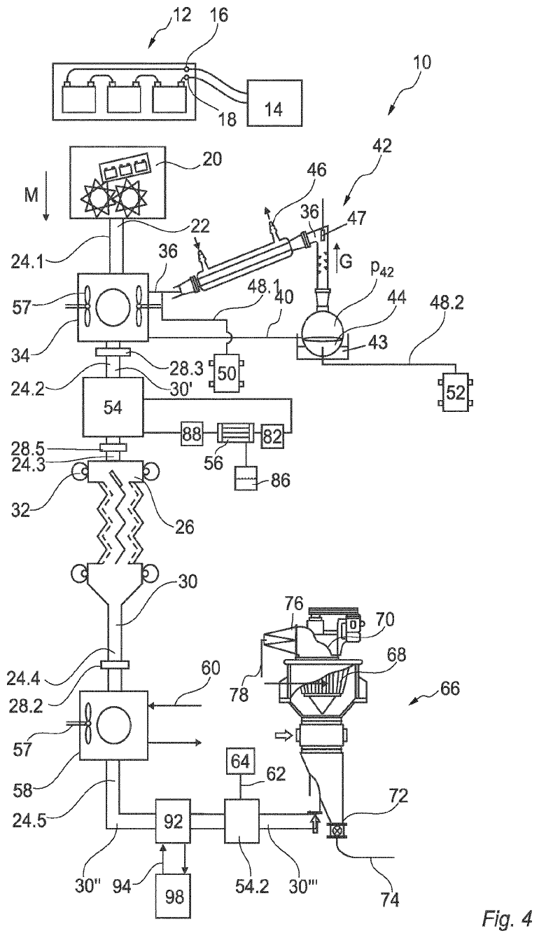

FIG. 4 a flow diagram of a battery processing system according to the invention in accordance with a fourth embodiment.

FIG. 1 shows a battery processing system 10 according to the invention for recycling alkali metal batteries 12, in the present case of lithium in the form of lithium ion rechargeable batteries. First, the alkali metal batteries 12 are preferably, but not necessarily, discharged by means of a discharge device 14. The electrical energy can be released into a power grid, such as the public power grid, but this is not essential.

Following discharging, the alkali metal batteries 12 are preferably, but not necessarily, short-circuited. In other words, a positive pole 16 and a negative pole 18 are connected to each other. An electrical resistance between the positive pole 16 and the negative pole 18 is preferably smaller than one fifth, especially one tenth, of an internal resistance of the corresponding alkali metal battery. Short-circuiting is performed over a short-circuiting time T_{K}. The short-circuiting time T_{K} is selected to be such that a regeneration cell voltage U_{reg} is below U_{reg}=0.15 V. For example, Tₛ=12 hours.

The alkali metal batteries 12 are comminuted in a comminution system 22, thereby obtaining comminuted material 22. The comminution system 20 is preferably designed in such a way that at most 5 percent by mass of the comminuted material 22 has a ball diameter of more than 4 cm. The ball diameter is the diameter of a imaginary sphere of minimum diameter that completely surrounds the corresponding object.

The comminuted material 22 is guided to an optional separating device 26 by means of a—preferably gas-tight—line 24.1. It is possible, but not essential, for an airlock 28.1 to be arranged between the comminution system 20 and the separating device in the direction of material flow M. The separating device 26 separates the black mass 30 from a residual fraction 32. The residual fraction 32 comprises, for example, plastic components of a housing or separator that is possibly provided.

The separating device 26 is depicted as a classifier, but it may—in general terms and not only in relation to the embodiment according to D1—also be a sieve system, a combination of sieve system and classifier, or a separating device based on another separating principle.

The black mass 30 (or the comminuted material 22 if there is no separating device 26) passes through a—preferably gas-tight—line 24.2 into a washing device 34, where it is brought into contact with a washing solvent 36. The washing solvent 36 dissolves conducting salt 38 out of the black mass 30, resulting in a washing liquid 40.

The washing liquid 40 goes into a regenerator 42 which may be designed as a vacuum distiller, as in the present case. The term vacuum distillation device may also be used instead of vacuum distiller. The regenerator 42 comprises a temperature control device 43 and separates the washing liquid 40 into at least a low-boiler fraction, formed by the washing solvent 36, and a high-boiler fraction 44.

The highest temperature in the vacuum distiller 42 at a point that is in contact with conducting salt is referred to as the regeneration temperature Tᵣ. Preferably Tᵣ≤60° C., for example Tᵣ=50° C. The temperature control device 43 sets the regeneration temperature Tᵣ.

A distillation pressure p₄₂ is present in the vacuum distiller 42. The distillation pressure p₄₂ is preferably selected in such a way that both ethyl methyl carbonate (EMC, carbonic acid ethyl methyl ester) and dimethyl carbonate (DMC, carbonic acid dimethyl ester) evaporate.

Preferably, the distillation pressure p₄₂ is selected in such a way that no substances evaporate whose boiling point at normal pressure (1013 hPa) is above a separation boiling point Tₜᵣₑₙₙ. Preferably Tₜᵣₑₙₙ>108° C., for example Tₜᵣₑₙₙ=110° C.

In the present embodiment, the gaseous EMC and DMC are condensed by means of a condenser 46 and guided back into the washing device 34 as washing solvent 36. Upstream of the condenser 46 in the direction of gas flow, a temperature around the separation boiling point Tₜᵣₑₙₙ can be prevalent. It is favourable to monitor this temperature using a thermometer 47.

Part of the washing solvent 36 can be extracted, for example by means of an extraction line 48.1, and fed to an electrolyte container 50. The washing solvent 36 can, possibly following further processing, be used to produce new alkali metal batteries.

The high-boiler fraction 44, which contains the conducting salt, remains in the vacuum distiller 42. The components of the high-boiler fraction 44 have a boiling point above the separation boiling point Tₜᵣₑₙₙ. The high-boiler fraction 44 is extracted, for example by means of a second extraction line 48.2, and can be fed to a transport container 52.

The distillation pressure p₄₂ is preferably lower than 286 hPa, in particular lower than 233 hPa, particularly preferably lower than 188 hPa, in particular lower than 150 hPa.

In the present embodiment, the low-boiler fraction contains substances with a boiling point at normal pressure between 85° C., especially 88° C., and 109° C. If the alkali metal batteries are lithium ion rechargeable batteries, the low-boiler fraction contains carbonic acid dimethyl ester and carbonic acid ethyl methyl ester in particular.

In the present embodiment, the low-boiler fraction 44 contains substances with a boiling point at normal pressure above 110° C.

In the present embodiment, the washing device 34 is operated in batch mode. Washing is carried out until the conducting salt in the washing liquid falls below a predetermined limit concentration C_{grenz}. The black mass 30 is then referred to as low-conducting salt black mass 30′. Preferably, the limit concentration C_{grenz} is selected in such a way that at least 95 percent by weight of the conducting salt is washed out of the black mass 30.

The low-conducting salt black mass 30′ passes through an optional airlock 28.3 into an optional dryer 54. As in the present case, the dryer 54 can be designed as a vacuum dryer; however, this is not essential. A dryer pressure p₅₄ of p₅₄≤300 hPa, for example, is then prevalent in the dryer 54. A dryer temperature T₅₄ in the dryer 54 is preferably below T₅₄=60° C. Washing solvent 36 in the low-conducting salt black mass 30′ is thus evaporated and condensed out in a condenser 56.

The dryer 54 preferably comprises a mixer 57 in order to improve the contact between the washing solvent 36 and the black mass and therefore the discharge of conducting salt and electrolyte components that do not form the washing solvent 36.

A binder removal system 58 is arranged downstream of the washing device 34 in the direction of material flow M and, in the present case, downstream of the dryer 54. The low-conducting salt black mass 30′ passes through a—preferably gas-tight—line 24.4 and, where applicable, through an airlock 28.4 into the binder removal system 58, where a binder solvent 60, such as dimethyl sulfoxide, is added to it.

As intended according to a preferred embodiment, if the binder solvent 60 contains supercritical carbon dioxide, the temperature and pressure in the binder removal system are selected in such a way that the carbon dioxide is supercritical.

Preferably, a binder removal temperature T₅₈ in the binder removal system 58 is as high as possible, in particular close to the boiling point T_{S,60} of the binder solvent 60. Preferably, the binder removal temperature is at least T_{S,60}=170° C. Preferably T_{S,60}=≤400° C., in particular T_{S,60}=≤375° C. In order to achieve the highest possible binder removal temperature, it is favourable if a process pressure p₅₈ in the binder removal system 58 is greater than the ambient pressure. Preferably p₅₈≥1200 hPa, in particular p₅₈≥2000 hPa. In particular p₅₈≤12 MPa.

The binder removal system 58 preferably has an agitator 60 for introducing mechanical energy into the low-conducting salt black mass 30′. It is beneficial if a pH value of at most 9 is prevalent in the binder removal system 58.

The binder removal system 58 is operated, for example, in batch operation. The binder solvent 60 is exchanged until at least 40%, preferably at least 50%, of the binder has been discharged from the low-conducting salt black mass 30′. The resulting low-binder black mass 30″ is subsequently dried in a dryer 54.2, for example by means of a line 24.5. It is possible, but not essential, that a temperature T_{54.2} prevails in the second dryer that is above a binder decomposition temperature T_{BZ}. Any exhaust gas 62 produced is purified by means of an exhaust gas purification system 64, in particular of hydrogen fluoride, and then released into the environment.

The low-binder black mass 30″ enters a separating device 66, which is designed as a fine classifier in the present case. The fine classifier 66 has a classifying wheel 68 which is brought up to a classifying wheel rotation frequency f₆₈ of, for example, f₆₈=150 1/s by means of a motor 70.

A coarse fraction 74 leaves the fine classifier 66 through a coarse fraction outlet 72 and a fine fraction 78 through a fine fraction outlet 76. The coarse fraction 74 contains significantly more graphite than the fine fraction 78 and can therefore be referred to as a graphite fraction. Conversely, the fine fraction 78 contains significantly more transition metal than the coarse fraction 74 and can therefore be referred to as a transition metal fraction.

FIG. 2 depicts a second embodiment of a battery processing system according to the invention in which the vacuum distiller 42 is designed as a rectifier, i.e. as a device for fractioned distillation.

In this case, it is favourable if the fraction with the lowest boiling point is used as washing solvent or has the highest percentage by weight of washing solvent 36.

FIG. 3 shows a third embodiment of a battery processing system 10 according to the invention for recycling alkali metal batteries 12, especially Li batteries or Na batteries, with (a) a comminution system 20 for comminuting the batteries, thereby obtaining comminuted material 22 that contains black mass 30, wherein the black mass contains, in particular, the active material and the binder, (b) a washing device 34 that is arranged downstream of the comminution system 20 in the direction of material flow and is designed to wash at least one fraction of the comminuted material 22, especially black mass 30, with a washing solvent 36, thereby obtaining low-conducting salt comminuted material 22 and a washing liquid 40, and (c) a regenerator 42 which (i) is designed to automatically regenerate washing solvent 36 from the washing liquid 40, and comprises (ii) a feed line that is connected to the washing device 34 for guiding washing liquid 40 from the washing device 34 to the regenerator 42 and (iii) a return line that is connected to the washing device 34 for guiding washing solvent 36 from the regenerator 42 to the washing device 34.

The battery processing system 10 has a pre-dryer 80, which is arranged downstream of the comminution system 20 and upstream of a separating device 26 in the direction of material flow M. In the pre-dryer a pressure p₅₄ of at most 300 hPa, for example p₅₄′=100 hPa, is prevalent. This negative pressure is generated by a vacuum pump 82.

As an option, a condenser 56′ may be arranged upstream (or alternatively downstream) of the vacuum pump 82 in the direction of gas flow G for condensing conducting salt solvent 86. The conducting salt solvent 84 can be used, for example, as washing solvent 36 or utilised directly.

As an option, a particulate filter 88 may be arranged upstream of the condenser 84 in the direction of gas flow G. As an option, an activated carbon filter 90 may be arranged downstream of the vacuum pump 82 in the direction of gas flow G. The gases purified in this manner can then be purified further or directly released into the environment.

The pre-dryer 80 can be connected to the separating device 26 by means of an airlock 28.5 and a—preferably particle-tight—line 24.6.

In the separating device 26 the black mass is separated 30 from the residual fraction 32. The residual fraction contains, in particular, heavy material, i.e. particles produced by comminuting the housing, as well as comminuted carrier foil and/or comminuted separator foils. The washing device 34 that washes the conducting salt out of the washing solvent 36 is arranged downstream of the separating device 26 in the direction of material flow.

As an option, the battery processing system 10 may comprise the dryer 54, which is arranged downstream of the washing device 34 in the direction of material flow.

As an option, the battery processing system 10 may comprise the binder removal system 58, which is arranged downstream of the washing device 34, in particular of the dryer 54 if provided, in the direction of material flow.

If the battery processing system 10 has a binder removal system 58, it may comprise an optional post-washer 92 by means of which the binder solvent 60 is washed out of the low-binder black mass 30″ with a binder wash-out solvent 94, thereby obtaining wash solution 96. Preferably, the battery processing system has a wash solution regenerator 98 for separating binder wash-out solvent 94 from the wash solution 96.

As an option, the battery processing system 10 has a classifier, in particular a fine classifier 66, for generating a graphite fraction and a transition metal fraction from the
possibly low-binder-black mass 30″.

As an option, the battery processing system 10 comprises the discharge device 14.

The battery processing system 10 can comprise all the components shown in FIG. 3, but this is not essential.

FIG. 4 shows a further embodiment of a battery processing system 10 according to the invention for recycling alkali metal batteries 12, especially Li batteries or Na batteries, with (a) a comminution system 20 for comminuting the batteries, thereby obtaining comminuted material 22 that contains black mass 30, wherein the black mass contains, in particular, the active material and the binder, (b) a washing device 34 that is arranged downstream of the comminution system 20 in the direction of material flow and is designed to wash at least one fraction of the comminuted material 22, especially black mass 30, with a washing solvent 36, thereby obtaining low-conducting salt comminuted material 22 and a washing liquid 40, and (c) a regenerator 42 which (i) is designed to automatically regenerate washing solvent 36 from the washing liquid 40, and comprises (ii) a feed line that is connected to the washing device 34 for guiding washing liquid 40 from the washing device 34 to the regenerator 42 and (iii) a return line that is connected to the washing device 34 for guiding washing solvent 36 from the regenerator 42 to the washing device 34.

In addition, the battery processing system 10 has a dryer 54 arranged downstream of the washing device 34 in the direction of material flow M. The dryer 54 may be a vacuum dryer in which a process pressure p₅₄ of, for example, at most p₅₄=300 hPa and/or a dryer temperature T₅₄ of, for example, at most T₅₄=70° C. is/are prevalent. The preferred dryer temperatures stated above also apply here.

Alternatively, the dryer 54 can work at normal pressure or an overpressure and/or a dryer temperature T₅₄ of over 70° C., especially over 80° C., for example above 90° C. For example, the dryer temperature is above the boiling temperature T_{S,36} of the washing solvent 36.

The separating device 26, in which the black mass is separated from the residual fraction 32, is arranged downstream of the dryer 54 in the direction of material flow. The residual fraction contains, in particular, heavy material, i.e. particles produced by comminuting the housing, as well as comminuted carrier foil and/or comminuted separator foils.

As an option, the battery processing system 10 comprises a binder removal system 58 in which binder solvent 60 is used to dissolve out binder in the black mass 30. As an option, the battery processing system 10 has a further dryer 54.2 for drying the low-binder black mass 30″.

If the battery processing system 10 has a binder removal system 58, it may comprise an optional post-washer 92 by means of which the binder solvent 60 is washed out of the low-binder black mass 30″ with a binder wash-out solvent 94, thereby obtaining wash solution 96. Preferably, the battery processing system has a wash solution regenerator 98 for separating binder wash-out solvent 94 from the wash solution 96.

As an option, the battery processing system 10 has a classifier, in particular a fine classifier 66, for generating a graphite fraction and a transition metal fraction from the—possibly low-binder-black mass 30″.

The battery processing system 10 can comprise all the components shown in FIG. 4, but this is not essential.

For example, the battery processing system 10 does not have a dryer and/or separating device upstream of the binder removal system 58 in the direction of material flow.

Reference list

| | | | |
|---|---|---|---|
| 10 | battery processing system | 46 | condenser |
| 12 | alkali metal battery | 47 | thermometer |
| 14 | discharge device | 48 | extraction line |
| 16 | positive pole | | |
| 18 | negative pole | 50 | electrolyte container |
| | | 52 | transport container |
| 20 | comminution system | 54, 54′ | dryer |
| 22 | comminuted material | 56 | condenser |
| 24 | line | 57 | mixer |
| 26 | separating device | 58 | binder removal system |
| 28 | airlock | | |
| | | 60 | binder solvent |
| 30 | black mass | 62 | exhaust gas |
| 32 | residual fraction | 64 | exhaust gas purification |
| | | | system |
| 34 | washing device | 66 | fine classifier |
| 36 | washing solvent | 68 | classifying wheel |
| 38 | conducting salt | | |
| | | 70 | motor |
| 40 | washing liquid | 72 | coarse fraction outlet |
| 42 | regenerator | 74 | coarse fraction |
| 43 | temperature control device | 76 | fine fraction outlet |
| 44 | high-boiler fraction | 78 | fine fraction |
| 82 | vacuum pump | | |
| 84 | condenser | | |
| 86 | conducting salt solvent | | |
| 88 | particulate filter | | |
| 90 | activated carbon filter | | |
| 92 | post-washer | | |
| 94 | binder wash-out solvent | | |
| 96 | wash solution | | |
| c_{grenz} | limit concentration | | |
| f₆₈ | classifying wheel rotation | | |
| | frequency | | |
| G | direction of gas flow | | |
| M | direction of material flow | | |
| p₄₂ | distiller pressure | | |
| p₅₄ | process pressure | | |
| p₅₈ | process pressure in the | | |
| | binder removal system | | |
| T_{S, 36} | boiling point of the washing | | |
| | solvent | | |
| T₅₄ | dryer temperature | | |
| T_{K} | short-circuit time | | |
| Tᵣ | regeneration temperature | | |
| U_{reg} | regeneration cell voltage | | |

1. A method for recycling alkali metal batteries, comprising
(a) an active material,
(b) a carrier foil on which the active material is arranged,
(c) binder with which the active material is bonded with the carrier foil,
(d) a liquid electrolyte, wherein the liquid electrolyte contains a conducting salt solvent,
(e) conducting salt, and
(f) a housing that surrounds the active material, carrier foil and binder,
comprising the steps of
(i) comminuting the alkali metal batteries, resulting in a comminuted material comprising black mass (30) which contains the active material and the binder,
(ii) washing the comminuted material with a washing solvent so that the conducting salt is washed out and the binder is not washed out, thereby obtaining a low-conducting salt comminuted material and a washing liquid,
(iii) regenerating the washing solvent from the washing liquid, and
(iv) wherein the step of washing the comminuted material is performed with at least part of the regenerated washing solvent.

2. The method according to claim 1, wherein after comminuting the alkali metal batteries, further comprising the step of separating the black mass from a residual fraction, and wherein the step of washing the comminuted material washes the black mass with the washing solvent.

3. The method according to claim 1 wherein a main component of the washing solvent, measured in percent by weight deviates by at most a factor of 10 from a main component of the conducting salt solvent.

4. The method according to claim 1 wherein
(a) the washing solvent is essentially not brought into contact with water, and
(b) the regeneration of the washing solvent comprises a distillation and a separation of the conducting salt from the washing liquid.

5. The method according to claim 0, wherein the regeneration of the washing solvent comprises vacuum distillation performed at a regeneration temperature of at most 70° C. and/or a pressure below a vapour pressure of the washing solvent at the regeneration temperature.

6. The method according to claim 1 further comprising
(i) drying the comminuted material at a temperature of at most 60° C. and a pressure of at most 300 hPa, and
(ii) before washing the comminuted material with at least part of the regenerated washing solvent, separating foil components from the comminuted material.

7. The method according to claim 1 wherein after the comminuting step, and before or after any step of separating foil components, and before washing the comminuted material, pre-drying the comminuted material, wherein the pre-drying is performed such that at least 50 percent by weight of the electrolyte solvent is removed.

8. The method according to claim 1 further comprising
(a) drying the comminuted material, resulting in dried comminuted material,
(b) separating plastic particles, from the dried comminuted material, thereby obtaining black mass, and
(c) washing the black mass with the washing solvent.

9. The method according to claim 1 wherein step after washing the comminuted material, dissolving binder out of the low-conducting salt comminuted material with a binder solvent, thereby obtaining a low-binder comminuted material.

10. The method according to claim 1 further comprising fine-classifying one or more of the comminuted material, the low-conducting salt comminuted material, or a low-binder comminuted material.

11. (canceled)

12. The method according to claim 8 wherein the steps prior to washing the black mass are carried out in such that a conducting salt of the alkali metal batteries decomposes to at most 2 percent by weight.

13. The method according to claim 1 wherein
(a) the comminuted material is not brought into contact with water before washing,
(b) the conducting salt is not decomposed,
(c) the active material and/or an electrolyte present in the alkali metal batteries is not brought into contact with water before and during comminution,
(d) the alkali metal batteries, the comminuted material and/or black mass in the comminuted material are not pyrometallurgically treated, before washing, and
(e) comminuting is performed at a temperature that at most 2.5 mole % of fluorine present in the comminuted material decomposes in relation to an entirety of the comminuted material.

14. A battery processing system, comprising:
(a) a comminution system for comminuting the batteries by pressure comminuting, impact comminuting, friction comminuting, cutting comminuting, and/or impact comminuting, thereby obtaining comminuted material-which contains black mass that contains the active material and binder,
(b) a washing device designed and arranged to wash at least one fraction of the comminuted material, with a washing solvent, thereby obtaining low-conducting salt comminuted material and a washing liquid, and
(c) a regenerator which
(i) is designed to automatically regenerate washing solvent from the washing liquid,
(ii) comprises a feed line connected to the washing device for guiding washing liquid from the washing device to the regenerator, and
(iii) a return line connected to the washing device for guiding washing solvent from the regenerator to the washing device.

15. The battery processing system according to claim 0 wherein the regenerator is a vacuum distiller designed to automatically distil a low-boiler fraction of the washing liquid, wherein the low-boiler fraction forms the washing liquid used by the washing device.

16. The battery processing system according to claim 0 further comprising:
(a) a separating device designed and arranged to separate black mass from a residual fraction, wherein the separating device is arranged downstream of the comminution system in a direction of material flow and/or
(b) a pre-dryer arranged downstream of the comminution system and upstream of a separating device in the direction of material flow and/or
(c) a dryer arranged downstream of the washing device in the direction of material flow.

17. The battery processing system according to claim 0 further comprising a pre-dryer arranged downstream of the comminution system and upstream of the washing device in a direction of material flow.

18. The battery processing system according to claim 14 further comprising
a binder removal system arranged downstream of the washing device in a direction of material flow, wherein the binder removal system (M) and is designed to automatically dissolve binder out of the low-conducting salt comminuted material using a binder solvent to form a low-binder black mass.

19. The battery processing system according to claim 18 further comprising a classifier for classifying the low-binder black mass for generating a graphite fraction and a transition metal fraction in which at least one transition metal is enriched compared to the graphite fraction, wherein the classifier is a fine classifier that comprises a classifying wheel.

20. The method according to claim 1, wherein after the step of washing the comminuted material, further comprising the step dissolving the binder out of the low-conducting salt comminuted material with a binder solvent thereby obtaining low-binder comminuted material.

21. The method according to claim 20 further comprising the step of separating the low-binder comminuted material, thereby obtaining a graphite fraction and a transition metal fraction, in which at least one transition metal is enriched compared to the graphite fraction.

22. The method according to claim 20, wherein after step (iv)
(a) drying the low-conducting salt comminuted material, and
(b) after the drying the low-conducting salt comminuted material and before dissolving the binder out of the low-conducting salt comminuted material with the binder solvent, separating foil parts and/or particles of comminuted housing.

23. The method according to claim 6 wherein the separated foil components comprise plastic foil components and/or metal foil components.
